(19) United States
(12) Patent Application Publication
(10) Pub. No.: US 2026/0102760 A1
(43) Pub. Date: Apr. 16, 2026

(54) METHODS FOR PREPARING MOLECULAR SIEVES USING 1,1-DIETHYL-2,6-DIMETHYLPIPERIDIN-1-IUM AND MOLECULAR SIEVES PREPARED THEREFROM

(71) Applicant: BASF Mobile Emissions Catalysts LLC, lselin, NJ (US)

(72) Inventors: Vivek VATTIPALLI, Iselin, NJ (US); Ahmad MOINI, Iselin, NJ (US); Eduard L. KUNKES, Ludwigshafen Am Rhein (DE)

(21) Appl. No.: 19/116,694

(22) PCT Filed: Sep. 27, 2023
(86) PCT No.: PCT/US2023/075185

§ 371 Date: Mar. 28, 2025

(30) Foreign Application Priority Data
Sep. 29, 2022 (EP) 22198711.8

(51) Int. Cl. B01J 29/76; B01D 53/94; B01J 35/61; B01J 37/08; B01J 37/30; C01B 39/48; F01N 3/20; F01N 3/28

(52) U.S. Cl. CPC B01J 29/763; B01D 53/9418; B01J 35/615; B01J 35/617; B01J 37/08; B01J 37/30; C01B 39/48; F01N 3/2066; F01N 3/2803; B01D 2255/20761; B01D 2255/50; B01D 2255/9207; B01D 2257/404; B01D 2258/01; B01J 2229/186; B01J 2229/37; C01P 2002/60; C01P 2002/72; C01P 2004/03; C01P 2006/12; F01N 2370/04

(57) ABSTRACT

A method for preparing a molecular sieve, wherein the method comprises forming a synthesis gel comprising an aluminum source, a silicon source, an organic structure directing agent, water, an alkali source, and, optionally a seed crystal; and heating the synthesis gel to obtain the molecular sieve; wherein the organic structure directing agent comprises a 1,1-diethyl-2,6-dimethylpiperidin-1-ium cation, and the molecular sieve comprises a framework type that is not AEI. Also disclosed are molecular sieves prepared according to the disclosed methods, selective catalytic reduction catalysts comprising the disclosed molecular sieves, and methods for selective catalytic reduction using the disclosed selective catalytic reduction catalysts.

Disclosed herein are methods for preparing a molecular sieve, wherein the method comprises forming a synthesis gel comprising an aluminum source, a silicon source, an organic structure directing agent, water, an alkali source, and, optionally a seed crystal; and heating the synthesis gel to obtain the molecular sieve; wherein the organic structure directing agent comprises a 1,1-diethyl-2,6-dimethylpiperidin-1-ium cation, and the molecular sieve comprises a framework type that is not AEI. Also disclosed are molecular sieves prepared according to the disclosed methods, selective catalytic reduction catalysts comprising the disclosed molecular sieves, and methods for selective catalytic reduction using the disclosed selective catalytic reduction catalysts.

Internal combustion engines, combustion installations, and nitric acid production plants emit nitrogen oxide (NOₓ)-containing gas mixtures, generating atmospheric pollution that may contribute to environmental health hazards such as smog and acid rain. Various methods may be employed to reduce NOₓ-associated atmospheric pollution, including the catalytic reduction of nitrogen oxides. For example, carbon monoxide, hydrogen, or a lower hydrocarbon may be used as a reducing agent in a nonselective NOₓ reduction process. Alternatively, ammonia or an ammonia precursor (such as, e.g., urea) may be used as a reducing agent in a selective NOₓ reduction process referred to as Selective Catalytic Reduction (SCR). In SCR, a high degree of nitrogen oxide removal can be achieved using a small amount of a reducing agent.

Molecular sieves have been employed as catalysts for SCR and other reactions, including, e.g., methanol-to-olefins (MTO) reactions. Molecular sieves are aluminosilicate materials having substantially regular porous structures, with typical pore sizes ranging from 3 Å to 10 Å in diameter, that may be useful as catalysts. Illustratively, certain molecular sieves having 8-ring pore openings and double-six ring secondary building units have been employed as SCR catalysts. An example of a molecular sieve framework is chabazite (CHA), a small-pore molecular sieve structure with 8 membered-ring pore openings accessible through its 3-dimensional porosity. The connection of double 6-ring building units by 4 rings gives chabazite a cage-like structure. AEI and AFX type molecular sieves are alternative, non-limiting examples of small-pore caged molecular sieves that may also be useful in catalysts, including catalysts for the selective reduction of nitrogen oxides.

Novel synthesis pathways and molecular sieve morphologies may result in molecular sieves with improved performance in SCR and/or other applications. The choice of molecular sieve synthesis pathway may affect the resulting molecular sieve's structure, stability, and/or activity. Illustratively, defect density in a molecular sieve framework may affect the molecular sieve's hydrothermal stability and/or catalytic activity.

Selective catalytic reduction catalysts are commonly exposed to high temperature hydrothermal conditions. Under harsh hydrothermal conditions, the activity of transition metal ion-exchanged molecular sieves may decline.

Accordingly, there is a need for molecular sieves with, e.g., enhanced selective catalytic reduction and improved methods for preparing the same.

Disclosed are methods for preparing a molecular sieve, wherein the method comprises: forming a synthesis gel comprising an aluminum source, a silicon source, an organic structure directing agent, water, an alkali source, and optionally a seed crystal; and heating the synthesis gel to obtain the molecular sieve; wherein the organic structure directing agent comprises a 1,1-diethyl-2,6-dimethylpiperidin-1-ium cation, and the molecular sieve comprises a framework type that is not AEI. As used herein, the expression “molecular sieve comprises a framework type that is not AEI” means that the zeolite may be predominantly a framework other than AEI, such as CHA, but may suitably include a minor amount of AEL. For example, a molecular sieve that comprises a framework type that is not AEI may include 0% to 10% AEI, or more preferably 0% to 5% of AEI, as determined by peak area from XRD.

In some embodiments, the aluminum source is chosen from Molecular sieve Y (Faujasite), a compound of the formula Al(OR)₃, an aluminum oxide, an aluminum hydroxide, and combinations thereof, and wherein R is chosen from C₂ to C₅ alkyl groups.

In some embodiments, the silicon source is chosen from Molecular sieve Y (Faujasite), sodium silicate, colloidal silica, fumed silica, precipitated silica, and combinations thereof.

In some embodiments, the organic structure directing agent comprises 1,1-diethyl-2,6-dimethylpiperidin-1-ium hydroxide.

In some embodiments, the alkali source comprises at least one element chosen from sodium and potassium.

In some embodiments, the heating step is performed at a temperature ranging from 100° C. to 200° C. for a duration ranging from 30 minutes to 100 hours.

In some embodiments, the molecular sieve comprises a CHA framework type.

In some embodiments, the molecular sieve has a degree of crystallinity ranging from 50% to 100%.

In some embodiments, the molecular sieve comprises from 50% to 100% CHA framework type by total crystalline phase intensity as determined by x-ray diffraction.

In some embodiments, the synthesis gel comprises the seed crystal, and the seed crystal comprises a CHA framework type.

In some embodiments, the synthesis gel has one or more of the following properties: a SiO₂:Al₂O₃ ratio ranging from 15 to 50, an Na:Si ratio ranging from 0.1 to 1, a ratio of 1,1-diethyl-2,6-dimethylpiperidin-1-ium cation to Si ranging from 0.01 to 0.3, an OH:Si ratio ranging from 0.1 to 1, and an H₂O:Si ratio ranging from 5 to 50.

In some embodiments, the molecular sieve has an average crystal diameter ranging from 0.1 μm to 2 μm as determined by scanning electron microscopy.

In some embodiments, the organic structure directing agent comprises trimethyladamantylammonium cation.

In some embodiments, the molecular sieve is a Na form molecular sieve and the method further comprises one or more steps chosen from: ion-exchanging the Na form molecular sieve with an aqueous ammonium solution to obtain an NH₄⁺ form molecular sieve, calcining the NH₄⁺ form molecular sieve at a temperature ranging from 200° C. to 800° C. for a duration ranging from 30 minutes to 12 hours to obtain an H form molecular sieve, ion-exchanging and/or impregnating the H form molecular sieve with a transition metal M to obtain an M form molecular sieve calcining the M form molecular sieve at a temperature ranging from 200° C. to 800° C. for a duration ranging from 30 minutes to 12 hours.

In some embodiments, the transition metal M is chosen from iron, copper, and combinations thereof.

Disclosed are molecular sieves prepared according to the disclosed methods.

Disclosed are CHA molecular sieves comprising 1,1-diethyl-2,6-dimethylpiperidin-1-ium.

In some embodiments, the molecular sieve has at least one property chosen from: a silica to alumina molar ratio ranging from 5 to 50, a molecular sieve surface area ranging from 450 m²/g to 650 m²/g, and a matrix surface area ranging from 5 m²/g to 50 m²/g.

Disclosed are selective catalytic reduction catalysts comprising a Cu form molecular sieve prepared according to the disclosed methods.

Disclosed are methods for selective catalytic reduction of nitrogen oxides in an exhaust gas, wherein the method comprises contacting the exhaust gas with a disclosed selective catalytic reduction catalyst.

### BRIEF DESCRIPTION OF THE DRAWINGS

FIG. 1 depicts scanning electron microscopy images of exemplary embodiments of the disclosure.

FIG. 2 depicts x-ray diffraction patterns of exemplary embodiments of the disclosure.

FIG. 3 depicts x-ray diffraction patterns of exemplary embodiments of the disclosure.

FIG. 4 depicts selective catalytic reduction activity of exemplary embodiments of the disclosure.

FIG. 5 depicts selective catalytic reduction activity of exemplary embodiments of the disclosure.

FIG. 6A depicts an SEM image of example L.

FIG. 6B depicts another SEM image of example L.

FIG. 7 depicts x-ray diffraction patterns of example L after calcination.

### DEFINITIONS

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein, the term “material” refers to the elements, constituents, and/or substances of which something is composed or can be made.

As used herein, the term “calcination” refers to heating a solid to an elevated temperature (i.e., above-ambient temperature) in air or oxygen, such as, e.g., to remove impurities or volatile substances from the solid.

As used herein, the term “aluminum source” refers to a material comprising aluminum and/or aluminum ions, such as, e.g., aluminum salts, aluminum isopropoxide, and/or aluminum hydroxide.

As used herein, the term “catalyst” or “catalyst composition” refers to a molecule or a material that promotes a reaction.

As used herein, the term “copper source” refers to a material comprising copper and/or copper ions, such as, e.g., a copper salt and/or a copper complex, such as, e.g., copper-tetraethylenepentamine.

As used herein, the term “ion exchange treatment” refers to a process by which one or more ions are incorporated into and/or removed from a molecular sieve. As a non-limiting example, a molecular sieve may be subjected to a copper ion-exchange treatment by, e.g., mixing the molecular sieve with a material comprising copper such as, e.g., CuO, and a solution, such as, e.g., an aqueous zirconium acetate solution.

As used herein, the term “molecular sieve” refers to a material possessing a substantially regular porous structure. In some embodiments, molecular sieves are capable of selectively sorting molecules based on size exclusion. In some embodiments, the molecular sieve is a zeolite.

As used herein, molecular sieve, e.g., zeolite, framework types are as classified by the Structure Commission of the International Zeolite Association according to the rules of the IUPAC Commission on Zeolite Nomenclature. According to this classification, zeolite framework types are assigned a three letter code and are described in the Atlas of Zeolite Framework Types, 5th edition, Elsevier, London, England (2001).

As used herein, the term “organic structure directing agent” refers to an organic compound capable of affecting the morphology and/or structure of a molecular sieve.

For example, an organic structure directing agent may be an ionic organic molecule capable of being incorporated into the molecular sieve's structure. An organic structure directing agent may, e.g., comprise a large and/or sterically bulky organic group. An organic structure directing agent may, e.g., comprise an adamantammonium group. Trimethyl adamantammonium is a non-limiting example of an organic structure directing agent.

As used herein, the term “reducing agent” refers to a molecule or a material capable of reducing NOₓ at an elevated (i.e., above-ambient) temperature. Non-limiting examples of reducing agents include ammonia, urea, and fuel.

As used herein, the term “selective catalytic reduction” (SCR) refers to a catalytic process of reducing nitrogen oxides using a reducing agent.

As used herein, the term “silica source” refers to a material comprising silicon and/or silicon oxides, such as, e.g., colloidal silica, silicates, sodium silicate, and/or Ludox AS-40.

As used herein, the term “small pore,” in reference to the dimensions of a material, refers to a material with pore openings smaller than 5 Å (such as, e.g., pore openings from 3 Å to 5 Å).

As used herein, the term “thermal treatment” refers to a process whereby a composition is subjected to an elevated temperature (i.e., an above-ambient temperature) for a duration of time.

As used herein, the term “zeolite” refers to an aluminosilicate material possessing a substantially regular porous structure. Zeolites of the present disclosure may possess many different framework structures with substantially regular porous structures of molecular dimensions. In some embodiments, zeolites of the present disclosure possess open 3D framework structures composed of corner-sharing TO₄ tetrahedra, wherein T is Al or Si. In some embodiments, non-framework cations balancing the charge of the anionic framework are loosely associated with the framework oxygens, and the remaining pore volume is filled with water molecules. In some embodiments, the non-framework cations are exchangeable. In some embodiments, the water molecules are removable.

The structures of molecular sieves of the present disclosure may be analyzed using routine techniques in the art, such as, e.g., x-ray diffraction (XRD). As a non-limiting example, the degree of crystallinity of a molecular sieve of the present disclosure may be determined by XRD analysis.

As used herein, “phase crystallinity” refers to a weight percentage of a specified crystalline phase by total weight of a molecular sieve.

As used herein, “1,1-diethyl-2,6-dimethylpiperidin-1-ium” refers to a cation having the following structure.

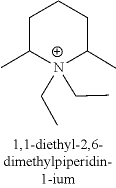

### Methods for Preparing Molecular Sieves:

Disclosed are methods for preparing a molecular sieve, wherein the method comprises: forming a synthesis gel comprising an aluminum source, a silicon source, an organic structure directing agent, water, an alkali source, and, optionally a seed crystal; and heating the synthesis gel to obtain the molecular sieve; wherein the organic structure directing agent comprises a 1,1-diethyl-2,6-dimethylpiperidin-1-ium cation, and the molecular sieve comprises a framework type that is not AEI.

In some embodiments, the aluminum source is chosen from Molecular sieve Y (Faujasite), a compound of the formula Al(OR)₃, an aluminum oxide, an aluminum hydroxide, and combinations thereof, and wherein R is chosen from C₂ to C₅ alkyl groups.

In some embodiments, the silicon source is chosen from Molecular sieve Y (Faujasite), sodium silicate, colloidal silica, fumed silica, precipitated silica, and combinations thereof.

In some embodiments, the Si source and Al source may be the same or different.

In some embodiments, the organic structure directing agent comprises 1,1-diethyl-2,6-dimethylpiperidin-1-ium hydroxide.

In some embodiments, the alkali source comprises at least one element chosen from sodium and potassium.

In some embodiments, the synthesis gel comprises the seed crystal, and the seed crystal comprises a CHA framework type.

In some embodiments, the heating step is performed at a temperature ranging from 100° C. to 200° C. for a duration ranging from 30 minutes to 100 hours.

In some embodiments, the synthesis gel has one or more of the following properties: a SiO₂:Al₂O₃ ratio ranging from 15 to 50, an Na:Si ratio ranging from 0.1 to 1, a ratio of 1,1-diethyl-2,6-dimethylpiperidin-1-ium cation to Si ranging from 0.01 to 0.3, an OH:Si ratio ranging from 0.1 to 1, and an H₂O:Si ratio ranging from 5 to 50.

In some embodiments, the synthesis gel has two or more of the following properties: a SiO₂:Al₂O₃ ratio ranging from 15 to 50, an Na:Si ratio ranging from 0.1 to 1, a ratio of 1,1-diethyl-2,6-dimethylpiperidin-1-ium cation to Si ranging from 0.01 to 0.3, an OH:Si ratio ranging from 0.1 to 1, and an H₂O:Si ratio ranging from 5 to 50.

In some embodiments, the synthesis gel has three or more of the following properties: a SiO₂:Al₂O₃ ratio ranging from 15 to 50, an Na:Si ratio ranging from 0.1 to 1, a ratio of 1,1-diethyl-2,6-dimethylpiperidin-1-ium cation to Si ranging from 0.01 to 0.3, an OH:Si ratio ranging from 0.1 to 1, and an H₂O:Si ratio ranging from 5 to 50.

In some embodiments, the synthesis gel has four or more of the following properties: a SiO₂:Al₂O₃ ratio ranging from 15 to 50, an Na:Si ratio ranging from 0.1 to 1, a ratio of 1,1-diethyl-2,6-dimethylpiperidin-1-ium cation to Si ranging from 0.01 to 0.3, an OH:Si ratio ranging from 0.1 to 1, and an H₂O:Si ratio ranging from 5 to 50.

In some embodiments, the synthesis gel has the following properties: a SiO₂:Al₂O₃ ratio ranging from 15 to 50, an Na:Si ratio ranging from 0.1 to 1, a ratio of 1,1-diethyl-2,6-dimethylpiperidin-1-ium cation to Si ranging from 0.01 to 0.3, an OH:Si ratio ranging from 0.1 to 1, and an H₂O:Si ratio ranging from 5 to 50.

In some embodiments, the organic structure directing agent comprises trimethyladamantylammonium cation.

In some embodiments, the method further comprises one or more steps chosen from: ion-exchanging the Na form molecular sieve with an aqueous ammonium solution to obtain an NH₄⁺ form molecular sieve, calcining the NH₄⁺ form molecular sieve at a temperature ranging from 200° C. to 800° C. for a duration ranging from 30 minutes to 12 hours to obtain an H form molecular sieve, ion-exchanging and/or impregnating the H form molecular sieve with a transition metal M to obtain an M form molecular sieve, calcining the M form molecular sieve at a temperature ranging from 200° C. to 800° C. for a duration ranging from 30 minutes to 12 hours treating the Na form molecular sieve with acid exchange or acid treatment to obtain the H-form molecular sieve, and ion-exchanging the Na form molecular sieve to obtain the M form molecular sieve.

In some embodiments, the method further comprises two or more steps chosen from: ion-exchanging the Na form molecular sieve with an aqueous ammonium solution to obtain an NH₄⁺ form molecular sieve, calcining the NH₄⁺ form molecular sieve at a temperature ranging from 200° C. to 800° C. for a duration ranging from 30 minutes to 12 hours to obtain an H form molecular sieve, ion-exchanging and/or impregnating the H form molecular sieve with a transition metal M to obtain an M form molecular sieve, and calcining the M form molecular sieve at a temperature ranging from 200° C. to 800° C. for a duration ranging from 30 minutes to 12 hours.

In some embodiments, the method further comprises three or more steps chosen from: ion-exchanging the Na form molecular sieve with an aqueous ammonium solution to obtain an NH₄⁺ form molecular sieve, calcining the NH₄⁺ form molecular sieve at a temperature ranging from 200° C. to 800° C. for a duration ranging from 30 minutes to 12 hours to obtain an H form molecular sieve, ion-exchanging and/or impregnating the H form molecular sieve with a transition metal M to obtain an M form molecular sieve, and calcining the M form molecular sieve at a temperature ranging from 200° C. to 800° C. for a duration ranging from 30 minutes to 12 hours.

In some embodiments, the method further comprises: ion-exchanging the Na form molecular sieve with an aqueous ammonium solution to obtain an NH₄⁺ form molecular sieve, calcining the NH₄⁺ form molecular sieve at a temperature ranging from 200° C. to 800° C. for a duration ranging from 30 minutes to 12 hours to obtain an H form molecular sieve, ion-exchanging and/or impregnating the H form molecular sieve with a transition metal M to obtain an M form molecular sieve, and calcining the M form molecular sieve at a temperature ranging from 200° C. to 800° C. for a duration ranging from 30 minutes to 12 hours.

In some embodiments, the transition metal M is chosen from iron, copper, and combinations thereof.

In some embodiments, the synthesis gel is heated to a temperature ranging from 90° C. to 200° C. for a reaction time ranging from of 0.1 hours to 160 hours. In some embodiments, the synthesis gel is heated to a temperature ranging from 120° C. to 200° C. for a reaction time ranging from of 1 hours to 160 hours. In some embodiments, the synthesis gel is heated to a temperature ranging from 140° C. to 190° C. for a reaction time ranging from of 10 hours to 160 hours. In some embodiments, the synthesis gel is heated to a temperature ranging from 140° C. to 190° C. for a reaction time ranging from of 20 hours to 100 hours.

In some embodiments, the synthesis gel further comprises at least one additional component chosen from sodium hydroxide, sulfuric acid, sodium sulfate, and combinations thereof.

### Molecular Sieves:

Disclosed are CHA molecular sieves comprising 1,1-diethyl-2,6-dimethylpiperidin-1-ium.

Disclosed are molecular sieves prepared according to the disclosed methods.

In some embodiments, the molecular sieve comprises a CHA framework type.

In some embodiments, the molecular sieve has a degree of crystallinity ranging from 50% to 100%. In some embodiments, the molecular sieve has a degree of crystallinity ranging from 60% to 100%. In some embodiments, the molecular sieve has a degree of crystallinity ranging from 70% to 95%. In some embodiments, the molecular sieve has a degree of crystallinity ranging from 80% to 95%.

In some embodiments, the molecular sieve comprises from 50% to 100% CHA framework type by total crystalline phase intensity as determined by x-ray diffraction.

In some embodiments, the molecular sieve comprises from 50% to 98% CHA framework type by total crystalline phase intensity as determined by x-ray diffraction. In some embodiments, the molecular sieve comprises from 50% to 95% CHA framework type by total crystalline phase intensity as determined by x-ray diffraction. In some embodiments, the molecular sieve comprises from 70% to 100% CHA framework type by total crystalline phase intensity as determined by x-ray diffraction. In some embodiments, the molecular sieve comprises from 80% to 98% CHA framework type by total crystalline phase intensity as determined by x-ray diffraction. In some embodiments, the molecular sieve comprises from 80% to 95% CHA framework type by total crystalline phase intensity as determined by x-ray diffraction.

In some embodiments, the molecular sieve has an average crystal diameter ranging from 0.1 μm to 2 μm as determined by scanning electron microscopy.

In some embodiments, the molecular sieve is a Na form molecular sieve. In some embodiments, the molecular sieve is a NH₄⁺ form molecular sieve. In some embodiments, the molecular sieve is a H form molecular sieve. In some embodiments, the molecular sieve is a M form molecular sieve wherein M is one or more transition metals. In some embodiments, the molecular sieve is a Cu form molecular sieve. In some embodiments, the molecular sieve is a Fe form molecular sieve.

In some embodiments, the molecular sieve has at least one property chosen from: a silica to alumina molar ratio ranging from 5 to 50, a molecular sieve surface area ranging from 450 m²/g to 650 m²/g, and a matrix surface area ranging from 5 m²/g to 50 m²/g.

In some embodiments, the molecular sieve has two or more properties chosen from: a silica to alumina molar ratio ranging from 5 to 50, a molecular sieve surface area ranging from 450 m²/g to 650 m²/g, and a matrix surface area ranging from 5 m²/g to 50 m²/g.

In some embodiments, the molecular sieve has the following properties: a silica to alumina molar ratio ranging from 5 to 50, a molecular sieve surface area ranging from 450 m²/g to 650 m²/g, and a matrix surface area ranging from 5 m²/g to 50 m²/g.

In some embodiments, the molecular sieve has a molecular sieve surface area in the range of 250 m²/g to 1000 m²/g. In some embodiments, the molecular sieve has a molecular sieve surface area in the range of 400 m²/g to 800 m²/g. In some embodiments, the molecular sieve has a molecular sieve surface area in the range of 500 m²/g to 600 m²/g.

In some embodiments, the molecular sieve has a matrix surface area in the range of 1 m²/g to 100 m²/g. In some embodiments, the molecular sieve has a matrix surface area in the range of 1 m²/g to 50 m²/g. In some embodiments, the molecular sieve has a matrix surface area in the range of 1 m²/g to 40 m²/g. In some embodiments, the molecular sieve has a matrix surface area in the range of 1 m²/g to 20 m²/g. In some embodiments, the molecular sieve has a matrix surface area in the range of 1 m²/g to 19 m²/g. In some embodiments, the molecular sieve has a matrix surface area in the range of 5 m²/g to 19 m²/g.

In some embodiments, the molecular sieve possesses greater than 90% primary phase crystallinity. In some embodiments, the molecular sieve possesses greater than 90% chabazite crystallinity. In some embodiments, the molecular sieve possesses less than 50% secondary phase crystallinity. In some embodiments, the molecular sieve possesses less than 10% secondary phase crystallinity. In some embodiments, the molecular sieve possesses less than 50% mordenite crystallinity. In some embodiments, the molecular sieve possesses less than 10% mordenite crystallinity. In some embodiments, the molecular sieve possesses less than 50% amorphous phase. In some embodiments, the molecular sieve possesses less than 10% amorphous phase. In some embodiments, the molecular sieve possesses greater than 50% primary phase crystallinity and a secondary phase crystallinity in the range of 1% to 50%. In some embodiments, the molecular sieve possesses greater than 80% primary phase crystallinity and a secondary phase crystallinity in the range of 1% to 20%. In some embodiments, the molecular sieve possesses greater than 90% primary phase crystallinity and a secondary phase crystallinity in the range of 1% to 10%. In some embodiments, the molecular sieve possesses greater than 50% chabazite and mordenite in the range of 1% to 50%. In some embodiments, the molecular sieve possesses greater than 80% chabazite and mordenite in the range of 1% to 20%. In some embodiments, the molecular sieve possesses greater than 90% chabazite and mordenite in the range of 1% to 10%. In some embodiments, the molecular sieve possesses greater than 80% chabazite and mordenite in the range of 1% to 20%. In some embodiments, the molecular sieve possesses greater than 90% chabazite and mordenite in the range of 0% to 10%.

In some embodiments, the molecular sieve is a Cu-form molecular sieve. In some embodiments, the Cu-form molecular sieve comprises an amount of copper in the range of 0.1 weight % to 20 weight %, calculated as CuO and based on the total weight of the molecular sieve. In some embodiments, the Cu-form molecular sieve comprises an amount of copper in the range of 0.1 weight % to 10 weight %, calculated as CuO and based on the total weight of the molecular sieve. In some embodiments, the Cu-form molecular sieve comprises an amount of copper in the range of 0.1 weight % to 5 weight %, calculated as CuO and based on the total weight of the molecular sieve. In some embodiments, the Cu-form molecular sieve comprises an amount of copper in the range of 1 weight % to 5 weight %, calculated as CuO and based on the total weight of the molecular sieve. In some embodiments, the Cu-form molecular sieve comprises an amount of copper in the range of 2 weight % to 5 weight %, calculated as CuO and based on the total weight of the molecular sieve.

In some embodiments, the molecular sieve has less than 20% extra framework aluminum by total aluminum content.

### Catalyst-Presenting Substrates:

Molecular sieves of the present disclosure may be deposited on a substrate. The substrate may be any material typically used for preparing catalysts, such as, e.g., a substrate with a ceramic or a metal honeycomb structure. Any suitable substrate may be employed, such as, e.g., a monolithic substrate having fine, parallel gas flow passages extending therethrough from an inlet or an outlet face of the substrate, such that passages are open to fluid flow therethrough (referred to as honeycomb flow through substrates). The passages, which may be essentially straight paths from their fluid inlet to their fluid outlet, can be defined by walls on which the molecular sieves deposited as a washcoat so that gases flowing through the passages contact the molecular sieves. The flow passages of the monolithic substrate may be thin-walled channels, which can be of any suitable cross-sectional shape and size, such as, e.g., trapezoidal, rectangular, square, sinusoidal, hexagonal, oval, or circular cross-sections. Such structures may contain from 60 to 400 or more gas inlet openings (i.e., cells) per square inch of cross-section.

The substrate can also be a wall-flow filter substrate, where the channels are alternately blocked, allowing a gaseous stream entering the channels from one direction (inlet direction), to flow through the channel walls and exit from the channels from the other direction (outlet direction). Molecular sieves of the present disclosure can be coated on the flow through or wall flow filter. If a wall flow substrate is utilized, the resulting system may be able to remove particulate matter along with gaseous pollutants such as, e.g., nitrogen oxides. The wall-flow filter substrate can be made from materials commonly known in the art, such as, e.g., cordierite, aluminum titanate, or silicon carbide. It will be understood that the loading of molecular sieves on a wall flow substrate will depend on substrate properties such as porosity and wall thickness, and typically will be lower than loading on a flow through substrate.

A ceramic substrate may be made of any suitable refractory material, such as, e.g., cordierite, cordierite-alumina, silicon nitride, zircon mullite, spodumene, alumina-silica magnesia, zircon silicate, sillimanite, a magnesium silicate, zircon, petalite, alpha-alumina, or an aluminosilicate.

Substrates useful for molecular sieves of the present disclosure may also be metallic in nature and be composed of one or more metals or metal alloys. The metallic substrates may be employed in various shapes, such as, e.g., corrugated sheet or monolithic form. Suitable metallic supports include the heat resistant metals and metal alloys, such as, e.g., titanium and stainless steel as well as other alloys in which iron is a substantial or major component. Such alloys may contain one or more of nickel, chromium, and/or aluminum, and the total amount of these metals may advantageously comprise at least 15 wt. % of the alloy, e.g., 10-25 wt. % of chromium, 3-8 wt. % of aluminum and up to 20 wt. % of nickel. The alloys may also contain small or trace amounts of one or more other metals, such as, e.g., manganese, copper, vanadium, or titanium. The surface or the metal substrates may be oxidized at high temperatures, such as, e.g., 1000° C. and higher, to improve corrosion resistance by forming an oxide layer on the substrates' surface. High temperature-induced oxidation may enhance the adherence of the refractory metal oxide support and catalytically promoting metal components to the substrate.

### Selective Catalytic Reduction Catalysts:

Disclosed are selective catalytic reduction catalysts comprising a disclosed molecular sieve disposed on a substrate.

In some embodiments, the molecular sieve is a Cu form molecular sieve.

### Methods of Treating an Exhaust Gas:

Disclosed are methods for selective catalytic reduction of nitrogen oxides in an exhaust gas, wherein the method comprises contacting the exhaust gas with a selective catalytic reduction catalyst disclosed herein.

### Non-Limiting Exemplary Embodiments:

Without limitation, embodiments exemplary disclosed embodiments include:

1. A method for preparing a molecular sieve, wherein the method comprises: forming a synthesis gel comprising an aluminum source, a silicon source, an organic structure directing agent, water, an alkali source and/or an alkaline earth metal source, and, optionally a seed crystal; and heating the synthesis gel to obtain the molecular sieve; wherein the organic structure directing agent comprises a 1,1-diethyl-2,6-dimethylpiperidin-1-ium cation, and the molecular sieve comprises a framework type that is not AEI.

2. The method according to embodiment 1, wherein the aluminum source is chosen from a zeolite, a compound of the formula Al(OR)₃, an aluminum oxide, an aluminum hydroxide, and combinations thereof, and wherein R is chosen from C₂ to C₅ alkyl groups.

3. The method according to embodiment 1 or 2, wherein the silicon source is chosen from a zeolite, sodium silicate, colloidal silica, fumed silica, precipitated silica, and combinations thereof.

4. The method according to any one of embodiments 1 to 3, wherein the organic structure directing agent comprises 1,1-diethyl-2,6-dimethylpiperidin-1-ium hydroxide.

5. The method according to any one of embodiments 1 to 4, wherein the synthesis gel comprises the alkali source and the alkali source comprises at least one alkali chosen from sodium and potassium.

6. The method according to any one of embodiments 1 to 5, wherein the heating step is performed at a temperature ranging from 100° C. to 200° C. for a duration ranging from 30 minutes to 100 hours.

7. The method according to any one of embodiments 1 to 6, wherein the molecular sieve comprises a CHA framework type.

8. The method according to any one of embodiments 1 to 7, wherein the molecular sieve has a degree of crystallinity ranging from 50% to 100%.

9. The method according to any one of embodiments 1 to 8, wherein the molecular sieve comprises from 50% to 100% CHA framework type by total crystalline phase intensity as determined by x-ray diffraction.

10. The method according to any one of embodiments 1 to 9, wherein the synthesis gel comprises the seed crystal, and the seed crystal comprises a CHA framework type.

11. The method according to any one of embodiments 1 to 10, wherein the synthesis gel has one or more of the following properties: a SiO₂:Al₂O₃ ratio ranging from 10 to 50, a M:Si ratio ranging from 0.1 to 1, a ratio of 1,1-diethyl-2,6-dimethylpiperidin-1-ium cation to Si ranging from 0.01 to 0.3, an OH:Si ratio ranging from 0.1 to 1, and an H₂O:Si ratio ranging from 5 to 50; wherein M is an alkali and/or an alkaline earth metal.

12. The method according to any one of embodiments 1 to 11, wherein the molecular sieve has an average crystal diameter ranging from 0.1 μm to 2 μm as determined by scanning electron microscopy.

13. The method according to any one of embodiments 1 to 12, wherein the organic structure directing agent comprises trimethyladamantylammonium cation.

14. The method according to any one of embodiments 1 to 13, wherein the molecular sieve is a Na form molecular sieve and the method further comprises one or more steps chosen from: ion-exchanging the Na form molecular sieve with an aqueous ammonium solution to obtain an NH⁴⁺ form molecular sieve, calcining the NH⁴⁺ form molecular sieve at a temperature ranging from 200° C. to 800° C. for a duration ranging from 30 minutes to 12 hours to obtain an H form molecular sieve, ion-exchanging and/or impregnating the H form molecular sieve with a transition metal M to obtain an M form molecular sieve, calcining the M form molecular sieve at a temperature ranging from 200° C. to 800° C. for a duration ranging from 30 minutes to 12 hours treating the Na form molecular sieve with acid exchange or acid treatment to obtain the H-form molecular sieve, and ion-exchanging the Na form molecular sieve to obtain the M form molecular sieve.

15. The method according to embodiment 14, wherein the transition metal M is chosen from iron, copper, and combinations thereof.

16. A molecular sieve prepared according to the method of any one of embodiments 1 to 15.

17. The molecular sieve according to embodiment 16, wherein the molecular sieve has at least one property chosen from: a silica to alumina molar ratio ranging from 5 to 50, a zeolite surface area ranging from 450 m²/g to 650 m²/g, and a matrix surface area ranging from 5 m²/g to 50 m²/g.

18. A selective catalytic reduction catalyst comprising a Cu form molecular sieve prepared according to the method of embodiment 14 or 15.

19. A method for selective catalytic reduction of nitrogen oxides in an exhaust gas, wherein the method comprises contacting the exhaust gas with a selective catalytic reduction catalyst according to embodiment 18.

20. A CHA zeolite comprising 1,1-diethyl-2,6-dimethylpiperidin-1-ium.

21. The method according to any one of embodiments 1 to 15, wherein the aluminum source is Zeolite Y (Faujasite).

22. The method according to any one of embodiments 1 to 15, wherein the silicon source is Zeolite Y (Faujasite).

Claims or descriptions that include “or” or “and/or” between at least one members of a group are considered satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or all the group members are present in, employed in, or otherwise relevant to a given product or process.

Furthermore, the disclosure encompasses all variations, combinations, and permutations in which at least one limitation, element, clause, and descriptive term from at least one of the listed claims is introduced into another claim. For example, any claim that is dependent on another claim can be modified to include at least one limitation found in any other claim that is dependent on the same base claim. Where elements are presented as lists, such as, e.g., in Markush group format, each subgroup of the elements is also disclosed, and any element(s) can be removed from the group. It should be understood that, in general, where the disclosure, or aspects of the disclosure, is/are referred to as comprising particular elements and/or features, embodiments of the disclosure or aspects of the disclosure consist, or consist essentially of, such elements and/or features. For purposes of simplicity, those embodiments have not been specifically set forth in haec verba herein. Where ranges are given, endpoints are included. Furthermore, unless otherwise indicated or otherwise evident from the context and understanding of one of ordinary skill in the art, values that are expressed as ranges can assume any specific value or sub range within the stated ranges in different embodiments of the disclosure, unless the context clearly dictates otherwise.

Those of ordinary skill in the art will recognize or be able to ascertain using no more than routine experimentation, many equivalents to the specific embodiments of the disclosure described herein. Such equivalents are intended to be encompassed by the following claims.

### EXAMPLES

The following examples are intended to be illustrative and are not meant in any way to limit the scope of the disclosure.

### Abbreviations

% percent
wt. % weight percent
SiO₂ silicon dioxide
Al₂O₃ aluminum oxide
Na₂O sodium oxide
H₂O water
FAU molecular sieve Y (Faujasite)
Na— FAU sodium form of molecular sieve Y (Faujasite)
NH₄⁺ ammonium ion
CuO Copper (II) oxide
N₂ dinitrogen
NO nitrogen oxide
NO₂ nitrogen dioxide
NOₓ nitrogen oxides
EF-Al extra-framework aluminum
MSA matrix surface area
ZSA molecular sieve surface area
SAR silica to alumina ratio
XRD X-ray diffraction

The following are exemplary processes by which exemplary molecular sieves were prepared.

### Procedure for Determining Percent Crystallinity

Samples were ground using a mortar and pestle and then backpacked into a flat-plate mount for analysis. A PANalytical MPD X'Pert Pro diffraction system was used to collect data in Bragg-Brentano geometry. CuKα radiation was used in the analysis with generator settings of 45 kV and 40 mA. The optical path consisted of a ⅛° divergence slit, 0.04 radian soller slits, 15 mm mask, ¼° anti-scatter slit, ⅛° anti-scatter slit, 0.04 radian soller slits, Ni filter, and X'Celerator linear position sensitive detector.

Data was collected from 3° to 70° 20 using a step size of 0.0167° 20 and a count time of 60 s per step. Jade Plus 9 analytical X-ray diffraction software was used for phase identification. The phases present were identified by search/match of the PDF-4/Full File database from ICDD, which is the International Center for Diffraction Data. Rietveld refinements were performed using Bruker AXS Topas software to determine the percentage of the crystalline phase(s) present.

### Characterization of Molecular Sieves

Pore volume and surface area characteristics were determined by nitrogen adsorption (BET surface area method). Mesopore and zeolitic (micropore) surface areas were determined via N₂-adsorption porosimetry on a Micromeritics TriStar 3000 series instrument, in accordance with ISO 9277 methods.

Procedure for N₂-Physisorption: Zeolite BET surface area analysis and nitrogen pore size distribution were analyzed on Micromeritics TriStar 3000 series instruments. The samples were degassed for a total of 6 hours (a 2 hour ramp up to 300° C. then held at 300° C. for 4 hours, under a flow of dry nitrogen) on a Micromeritics SmartPrep degasser. Nitrogen BET surface area was determined using 5 partial pressure points between 0.08 and 0.20. Nitrogen pore size (BJH) was determined using 33 desorption points.

Zeolitic and matrix surface areas were determined using the same 5 partial pressure points and calculated using Harkins and Jura t-plot. Pores having diameter greater than 20 Å are considered to contribute to matrix surface area (MSA).

### Synthesis of Molecular Sieves

Molecular sieves were prepared by forming a synthesis gel comprising an aluminum source, a silicon source, an organic structure directing agent, water, an alkali source, and, optionally a seed crystal; and heating the synthesis gel to obtain the molecular sieve. Tables 1 and 2 provide the raw material details, gel composition and crystallization conditions for the various example materials described. For materials B, G, H and L, sodium hydroxide and sodium sulfate are both sources of sodium in the synthesis such that the OH/Si ratio and Na/Si ratio specified are attained. For material F, potassium hydroxide is the sole source of potassium in the synthesis gel.

TABLE 1

| | | | | Gel properties | | | | | | | |
|---|---|---|---|---|---|---|---|---|---|---|---|
| | Al | Si | Seed | SiO₂/ | | | | | | | |
| Material | Source | Source | used?* | Al₂O₃ | Na/Si | K/Si | R₁^{&}/Si | R₂^{&}/Si | R₁/R₂^{&} | OH/Si | H₂O/Si |
| A | CBV720\hat{ } | CBV720\hat{ } | No | 33.0 | 0.389 | — | 0.265 | 0.027 | 10 | 0.68 | 18.1 |
| B | CBV100 | Sodium | Yes | 31.5 | 0.82 | — | 0.03 | 0.03 | 1 | 0.43 | 18.1 |
| | | silicate | | | | | | | | | |
| C | CBV720\hat{ } | CBV720\hat{ } | No | 33.0 | 0.389 | — | 0.265 | — | ∞ | .065 | 16.9 |
| D | CBV720\hat{ } | CBV720\hat{ } | Yes | 33.0 | 0.389 | — | 0.265 | — | ∞ | 0.65 | 16.9 |
| E | CBV720\hat{ } | CBV720\hat{ } | No | 33.0 | 0.389 | — | — | 0.027 | 0 | 0.42 | 18.0 |
| F | CBV720\hat{ } | CBV720\hat{ } | No | 33.0 | 0.389 | 0.265 | — | 0.027 | 0 | 0.68 | 16.9 |
| G | CBV100 | Sodium | No | 31.5 | 0.82 | — | 0.03 | 0.03 | 1 | 0.43 | 18.1 |
| | | silicate | | | | | | | | | |
| H | CBV100 | Sodium | No | 35.1 | 0.81 | — | — | 0.03 | 0 | 0.70 | 32.0 |
| | | silicate | | | | | | | | | |
| I | AlP# | Ludox | No | 20.0 | 0.13 | — | — | 0.07 | 0 | 0.20 | 11.0 |
| | | AS40 | | | | | | | | | |
| J | AlP# | Ludox | No | 22.0 | 0.05 | 0.05 | 0.05 | 0.05 | 1 | 0.10 | 14.9 |
| | | AS40 | | | | | | | | | |
| K | AlP# | Ludox | Yes | 22.0 | 0.05 | 0.048 | 0.048 | 0.048 | 1 | 0.10 | 14.9 |
| | | AS40 | | | | | | | | | |
| L | CBV300 | Ludox | No | 17.7 | 0.390 | — | 0.096 | — | ∞ | 0.20 | 13 |
| | | AS40 | | | | | | | | | |

CBV720\hat{ } is listed as SAR30 on the supplier (zeolyst) website, measurements done on sample used showed an SAR of 33
#AIP: Aluminium isopropoxide;
^{&}R₁: DEDMP, and R₂: TMAda
*Calcined CHA (SAR30) used as seed zeolite. 4 wt % seed (silica basis) was added; seed note considered in the calculation of gel mole ratios.
DEDMPOH: 2,6-dimethyl-1,1,diethyl piperidinium hydroxide;
TMAdaOH: 1,1,1-trimethyl adamantly ammonium hydroxide
^{&}R₁: DEDMP, and R₂: TMAda
DEDMPOH: 2,6-dimethyl-1,1,diethyl piperidinium hydroxide;
TMAdaOH: 1,1,1-trimethyl adamantly ammonium hydroxide

TABLE 2

| | Crystallization | | Product properties | | | | | | |
|---|---|---|---|---|---|---|---|---|---|
| | T | Time | | SiO₂/ | | C/N | | ZSA | MSA |
| Material | (° C.) | (h) | Phase(s)** | Al₂O₃ | Na/Al | (molar) | R₁/R₂** | (m²/g) | (m²/g) |
| A | 150 | 45 | CHA | ~15 | 0.56 | 11.7 | 1.9 | 561 | 12 |
| B | 160 | 30 | CHA | 17.5 | 0.87 | 11.6 | 2.3 | 524 | 27 |
| C | 150 | 45 | AEI | | | | | | |
| D | 150 | 45 | AEI | | | | | | |
| E | 150 | 45 | FAU, minor | | | | | | |
| | | | CHA | | | | | | |
| F | 150 | 45 | ERI | | | | | | |
| G | 160 | 30 | Am, minor Un | | | | | | |
| H | 140 | 72 | CHA | 10.9 | 0.76 | 12.7 | — | 506 | 11 |
| I | 170 | 30 | CHA | 19.8 | 0.51 | | | | |
| J | 170 | 45 | Am | | | | | | |
| K | 170 | 45 | CHA, Am | | | | | | |
| L | 160 | 72 | CHA, minor | 14.9 | | | | | |
| | | | MOR | | | | | | |

**Calculated on the basis of measured C/N mole ratios; C/N of DEDMPOH = 11; C/N of TMAdaOH = 13

In Table 2, “Am” denotes amorphous and “Un” denotes an unknown phase.

### Molecular Sieves

Properties of the prepared molecular sieves are described in Table 2.

Comparing material A with materials C through F, one observes the formation of CHA phase when using 1,1-diethyl-2,6-dimethylpiperidin-1-ium hydroxide (DEDMPOH). In the absence of TMAdaOH, a different zeolite phase (AEI) is synthesized as seen from materials C and D irrespective of whether CHA zeolite seed is used or not in these examples. In the absence of DEDMPOH, a minor CHA phase is seen in the product for material E. Since materials E and A differ in the OH/Si ratio, material F shows that an alternate source of OH⁻ ions (KOH) does not help synthesize CHA zeolite in this example. The lack of AEI zeolite formation in material A indicates that the structure directing role of the DEDMP⁺ cations is somewhat modified in the syntheses with both TMAdaOH and DEDMPOH to direct CHA zeolite formation.

The zeolite synthesized in material A contains C and N in the ratio 11.7 indicating incorporation of both OSDA cations in the product material. This is reported as the product R₁/R₂ ratio in Table 2, and was calculated from the elemental analysis data.

Material B describes another route to obtaining CHA zeolite containing both OSDA cations. In this example, it appears that the use of the CHA seed is assists in obtaining CHA zeolite as the product, since material G did not show formation of any CHA zeolite. Interestingly, the product R₁/R₂ ratio (Table 2) for material B is higher than the gel R₁/R₂ ratio (Table 1) in contrast to what is observed for material A.

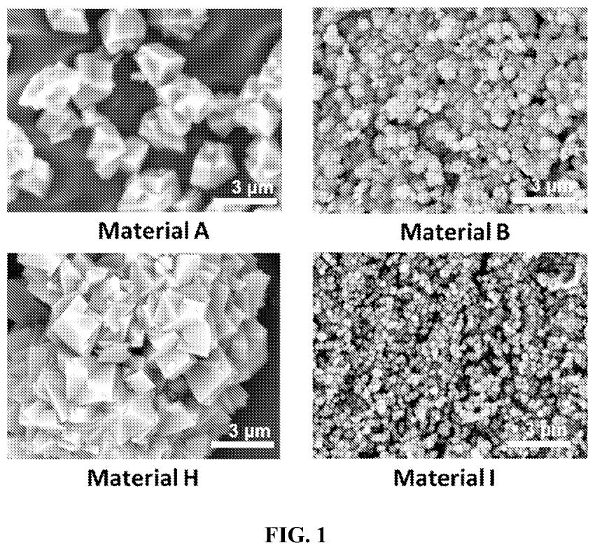

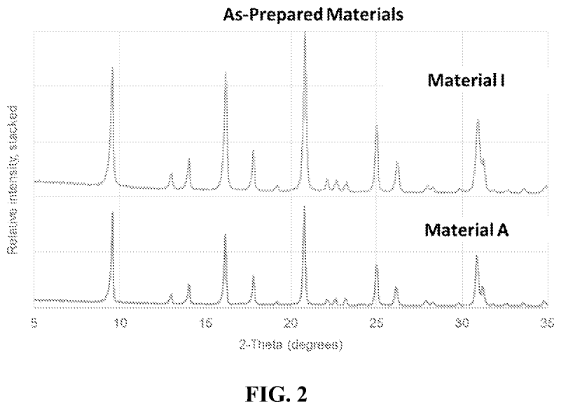

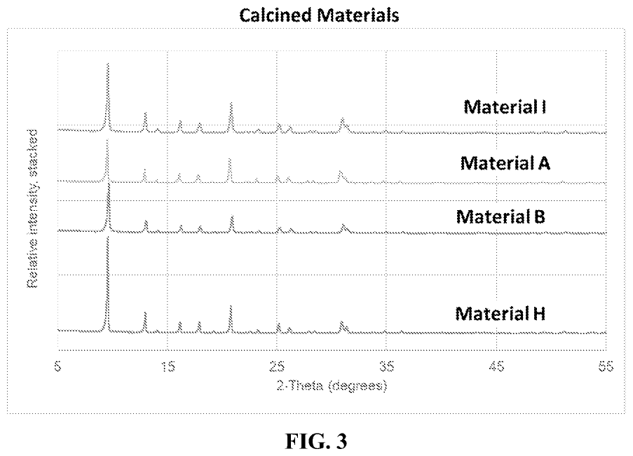

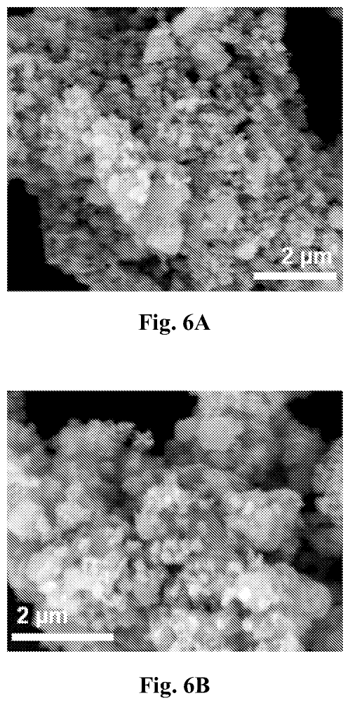

FIG. 1 depicts SEM images of materials A, B, H, and I. These materials had similar morphologies when observed by this technique. FIGS. 6A and 6B depict SEM images of material L.

While CHA zeolite materials A and B were prepared by synthesis using zeolitic sources of aluminium, it is believed that this similar processes using non-zeolitic aluminium sources would also produce CHA molecular sieves.

### Selective Catalytic Reduction Catalysts

SCR catalysts were prepared using materials A, B, H, and I as follows:

Ion exchange of Na-form zeolite: All the samples were ammonium exchanged to remove the alkali present in the pores and then subsequently calcined (450° C. for 6 h) to obtain the respective H-form materials.

Impregnation with Cu and formation of catalyst: The H-form zeolite powder was impregnated with an aqueous Copper (II) nitrate solution by incipient wetness impregnation and stored at 50° C. for 20 h in a sealed container. It was then dried and calcined at 450° C. for 5 hours, to obtain a Cu-loaded zeolite.

Catalyst formation: The test samples were prepared by slurrying the Cu-loaded zeolite with Zr-acetate as binder (5 wt. % ZrO₂) and then dried under stirring. This was followed by calcination at 550° C. for 1 hour. The obtained product was crushed and then aged at 650° C. in a flow of 10% steam/air mixture for 50 hours or at 820° C. in a flow of 10% steam/air mixture for 16 hours (as specified).

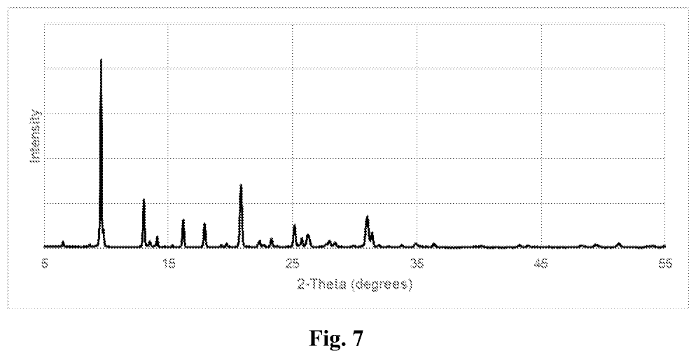

FIG. 7 shows the XRD data for example L after calcination.

### Selective Catalytic Reduction of Nitrogen Oxides

SCR measurements were carried out in a fixed-bed reactor with loading of 120 mg of respective test sample together with corundum of the same sieve fraction as diluent to about 1 mL bed volume, in accordance with following conditions.

1. Gas feed: 500 ppm NO, 500 ppm NH3, 5% H₂O, 10% O₂ and balance of N₂, with gas hourly space velocity (GHSV) 80,000 h⁻¹ (for samples aged at 820° C. for 16 h) and 120,000 h⁻¹ (for samples aged at 650° C. for 50 h);

2. Temperature: RUN1: 200° C., 400° C., 575° C. (first run for degreening)

3. RUN2: 175° C., 200° C., 225° C., 250° C., 500° C., 550° C., 575° C.

The 650° C. for 50 h aged samples were then subjected to simulated sulphur aging and regeneration as follows.

1. Each catalyst sample was placed downstream of a 2″ piece of DOC (diesel oxidation catalyst) such the gas flow first comes into contact with the DOC prior to reaching the catalyst evaluated.

2. In this configuration, the catalyst samples were heated to 400° C. (ramp rate of 10° C./min) and maintained at that temperature for 1 h in the presence of gas flow (8% H₂O, 7% CO₂, 10% 02 and balance N₂, with GHSV 10,000 h⁻¹).

3. Gas feed was switched to 35 ppm SO₂, 8% H₂O, 7% CO₂, 10% 02 and balance N₂, with GHSV 10,000 h¹ (i.e. the SO₂ was “switched on” in the feed for 96 h).

4. SO₂ was “switched off” in the gas feed and the sample was cooled to room temperature

5. For regeneration, the samples were heated to 550° C. (ramp rate of 10° C./min) and maintained at that temperature for 30 min in the presence of gas flow (8% H₂O, 7% CO₂, 10% 02 and balance N₂, with GHSV 20,000 h⁻¹)

6. The samples were then cooled to room temperature and SCR performance measurement was then performed as per the procedure described above.

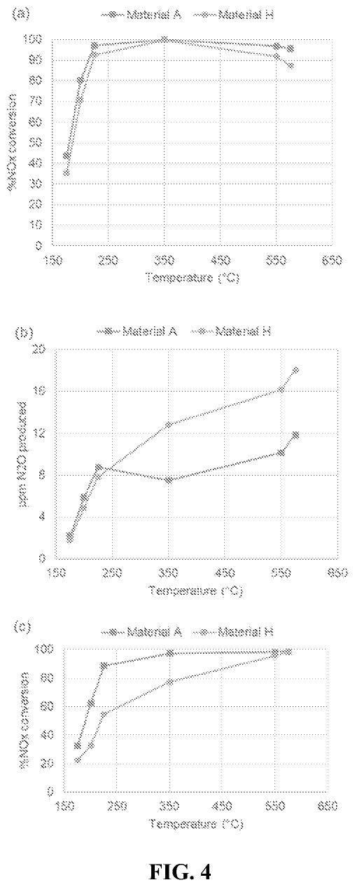

FIG. 4 compares the SCR performance of material A and material H after aging at 650° C. for 50 h at a similar Cu/Al ratio. It can be observed that the SCR performance of Cu loaded material A shows higher NOₓ conversion than that of material H across the temperature range of measurement. In addition, the amount of undesirable by-product N₂O produced in the process is lower for material A at temperatures of 350° C. or higher. Finally, the performance after S aging and regeneration (FIG. 4C) is significantly higher for material A as compared to material H highlighting the excellent durability of the catalyst prepared using material A.

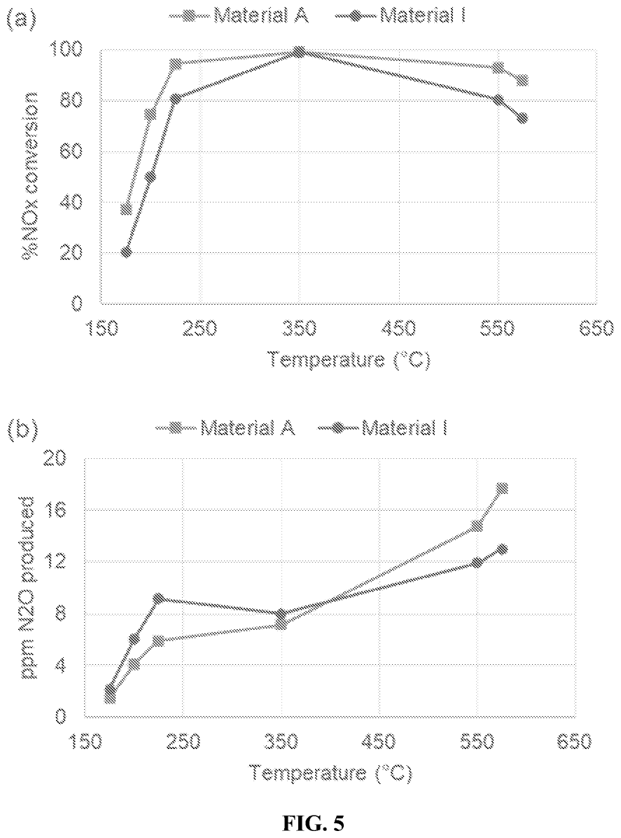

FIG. 5 compares the SCR performance of material A and material I after aging at 820° C. for 16 h at similar CuO loadings. It can be observed that the SCR performance of Cu loaded material A shows higher NOₓ conversion than that of material I across the temperature range of measurement. This is despite material I having a higher SAR which is may cause materials to have higher hydrothermal stability indicating that CHA zeolite materials of superior stability and activity can be synthesized using DEDMP as OSDA. In addition, the amount of undesirable by-product N₂O produced in the process is lower for material A at temperatures of 350° C. or lower.

1. A method for preparing a molecular sieve, wherein the method comprises:
forming a synthesis gel comprising an aluminum source, a silicon source, an organic structure directing agent, water, an alkali source and/or an alkaline earth metal source, and, optionally a seed crystal; and
heating the synthesis gel to obtain the molecular sieve,
wherein the organic structure directing agent comprises a 1,1-diethyl-2,6-dimethylpiperidin-1-ium cation, and the molecular sieve comprises a framework type that is not AEI.

2. The method according to claim 1, wherein
(a) the molecular sieve is a small-pore zeolite; and/or
(b) the aluminum source is chosen from a zeolite, a compound of the formula Al(OR)₃, an aluminum oxide, an aluminum hydroxide, and combinations thereof, and wherein R is chosen from C₂ to C₅ alkyl groups; and/or
(c) the silicon source is chosen from a zeolite, sodium silicate, colloidal silica, fumed silica, precipitated silica, and combinations thereof, and/or
(d) the organic structure directing agent comprises 1,1-diethyl-2,6-dimethylpiperidin-1-ium hydroxide.

3. The method according to claim 1, wherein the molecular sieve has a degree of crystallinity ranging from 50% to 100%.

4. The method according to claim 1, wherein the synthesis gel comprises the alkali source and the alkali source comprises at least one alkali chosen from sodium and potassium.

5. The method according to claim 1, wherein the heating step is performed at a temperature ranging from 100° C. to 200° C. for a duration ranging from 30 minutes to 100 hours.

6. The method according to claim 1, wherein the molecular sieve comprises a CHA framework type, and/or wherein the molecular sieve comprises from 50% to 100% CHA framework type by total crystalline phase intensity as determined by x-ray diffraction.

7. The method according to claim 1, wherein the synthesis gel comprises the seed crystal, and the seed crystal comprises a CHA framework type, and/or wherein the synthesis gel has one or more of the following properties:
a SiO₂ Al₂O₃ ratio ranging from 10 to 50,
an M:Si ratio ranging from 0.1 to 1,
a ratio of 1,1-diethyl-2,6-dimethylpiperidin-1-ium cation to Si ranging from 0.01 to 0.3,
an OH:Si ratio ranging from 0.1 to 1, and
an H₂O:Si ratio ranging from 5 to 50;
wherein M is an alkali and/or an alkaline earth metal.

8. The method according to claim 1, wherein the molecular sieve has an average crystal diameter ranging from 0.1 μm to 2 μm as determined by scanning electron microscopy.

9. The method according to claim 1, wherein the organic structure directing agent comprises trimethyladamantylammonium cation.

10. The method according to claim 1, wherein the molecular sieve is a Na form molecular sieve and the method further comprises one or more steps chosen from:
ion-exchanging the Na form molecular sieve with an aqueous ammonium solution to obtain an NH₄⁺ form molecular sieve,
calcining the NH₄⁺ form molecular sieve at a temperature ranging from 200° C. to 800° C. for a duration ranging from 30 minutes to 12 hours to obtain an H form molecular sieve,
ion-exchanging and/or impregnating the H form molecular sieve with a transition metal M to obtain an M form molecular sieve,
calcining the M form molecular sieve at a temperature ranging from 200° C. to 800° C. for a duration ranging from 30 minutes to 12 hours, and
treating the Na form molecular sieve with acid exchange or acid treatment to obtain the H-form molecular sieve, and
ion-exchanging the Na form molecular sieve to obtain the M form molecular sieve, optionally wherein the transition metal M is chosen from iron, copper, and combinations thereof.

11. A molecular sieve prepared according to the method of claim 1.

12. The molecular sieve according to claim 11, wherein the molecular sieve has at least one property, optionally at least two properties, chosen from:
a silica to alumina molar ratio ranging from 5 to 50,
a zeolite surface area ranging from 450 m²/g to 650 m²/g, and
a matrix surface area ranging from 5 m²/g to 50 m²/g.

13. A selective catalytic reduction catalyst comprising a Cu form molecular sieve prepared according to the method of claim 10.

14. A method for selective catalytic reduction of nitrogen oxides in an exhaust gas, wherein the method comprises contacting the exhaust gas with a selective catalytic reduction catalyst according to claim 13.

15. A CHA zeolite comprising 1,1-diethyl-2,6-dimethylpiperidin-1-ium.
